(19) United States
(12) Patent Application Publication
(10) Pub. No.: US 2026/0193839 A1
(43) Pub. Date: Jul. 9, 2026

(54) METHOD FOR SEPARATING AT LEAST ONE LIGNIN FRACTION, LIGNIN DERIVATIVES, LOW-MOLECULAR CARBOXYLIC ACIDS, INORGANIC SALT, OR A MIXTURE THEREOF FROM FILTRATES ORIGINATING FROM A KRAFT PROCESS

(71) Applicant: Mondi AG, Wien (AT)

(72) Inventors: Johannes LEITNER, Leonding (AT); Marlene KIENBERGER, Graz (AT); Silvia MAITZ, St. Mareing bei Graz (AT)

(73) Assignee: Mondi AG, Wien (AT)

(21) Appl. No.: 18/863,727

(22) PCT Filed: Jan. 10, 2024
(86) PCT No.: PCT/AT2024/060003

§ 371 Date: Nov. 7, 2024

(30) Foreign Application Priority Data
Jan. 11, 2023 (AT) A50012/2023

(51) Int. Cl. D21C 11/00; C08H 7/00

(52) U.S. Cl. CPC D21C 11/0042; C08H 6/00; D21C 11/0007

(57) ABSTRACT

A method for separating water and at least one lignin fraction, lignin derivatives, low-molecular carboxylic acids, sodium sulfate, or a mixture thereof from filtrates originating from a black liquor of a kraft process. Black liquor is concentrated to a solids content between 25 and 55 wt. %. A first separation step, polymer lignin with a number average of the molecular mass distribution of >6 kDa is precipitated and filtered out by lowering the pH value of the black liquor, a first filtrate is obtained which is acidified with sulfuric acid; a formed precipitate consisting of lignin is separated by means of filtration; a second acid filtrate is obtained, cooled to a temperature less than 10° C., a fraction consisting substantially of inorganic salts is crystallized out; the formed precipitate is filtered off, a third filtrate is obtained which contains low-molecular carboxylic acid-soluble lignin and groups of the inorganic salts.

### BACKGROUND OF THE INVENTION

The present invention relates to a method for separating water and at least one lignin fraction, lignin derivatives, low-molecular carboxylic acids, sodium sulfate or a mixture thereof from filtrates originating from black liquor of a kraft process.

Methods for fractionating black liquor in order to separate recyclable components contained in this black liquor or to separate the black liquor into different fractions have been used for many years and it is known, particularly in connection with the lignin or other organic components contained therein, that these can be used for a wide variety of purposes after they have been separated and, if necessary, purified. In recent years, a large number of processes have been described for the application and separation of lignin from a wide variety of processing liquors in paper and pulp manufacture. Known processes are, for example, the Ligno-Boost process (Ligno-Boost is a trademark of Valmet Aktiebolag), as described, for example, in WO 2011/037967, US 2011/294,991, and the Ligno-Force process, as described, for example, in U.S. Pat. No. 9,260,464 and also in WO 2011/037967. When lignin is separated by acid precipitation, the sulfide contained in the black liquor is protonated and gaseous H₂S is formed, which evaporates from the liquor. If precipitation is carried out with sulfuric acid, up to a Ph that is in the strongly acidic range, the precipitated lignin can be filtered off and the inorganic components contained in black liquor can be separated or recycled.

However, in addition to lignin and lignin with a wide range of molecular weights and/or degrees of polymerisation and the inorganic salts originating from the production, such as sodium sulfate, black liquor also contains a significantly larger number of organic substances which can be of great economic importance.

In addition to lignin, the mainly inorganic substances in the black liquor introduced into the process from the paper or paperboard production are also present as well as, depending on the cooking process used, a further relatively large variety of organic substances, such as carboxylic acids, lignosulfonates, soluble lignin and the like. It is generally known that lignin or its components or other substances are of economic importance and attempts have already been made to isolate it from black liquor, at least in part.

For example, U.S. Pat. No. 4,584,057 A describes the treatment of black liquor by ultrafiltration followed by electrodialytic separation of the permeate formed in order to separate in addition to lignin, aliphatic organic acids from the black liquor.

EP 3 978 681 A1 discloses a process for extracting lignin from black liquor, whereby the black liquor is separated and filtered several times.

WO 2015/025076 A1 discloses a method and a device for separating lignin from a liquid medium containing lignin, in which lignin is precipitated by acidification, separated and carbonized after resuspension.

It is also known that lignin has a variety of positive properties in a wide variety of processes. Thus, EP 3 900 546 describes a food composition containing lignin as a food supplement, which document in particular covers the advantages of adding such ingredients to food and luxury food items. The composition of additives containing lignin can have a positive effect on food compositions containing it and EP 3 900 546 discloses a number of combinations and examples with different kraft lignin.

Despite the many experiments carried out and processes used in which lignin or its components are used, a very major disadvantage is that a complete process by means of which not only lignin can be separated from black liquor, but also other inorganic salts contained therein as well as low-molecular organic carboxylic acids and derivatives or a mixture of various components, is not available. A further disadvantage of all known processes is that these processes work with relatively highly diluted mass flows and thus a large amount of process water is entrained during the2urifyication of the individual products, which in turn is associated with a high energy expenditure, whether this is for any necessary evaporation of the process water, the drying of separated products and the like, which makes the known processes unfavourable, especially from the point of view of the required energy consumption.

### SUMMARY OF THE INVENTION

The present invention therefore aims to provide a fractional purification process by means of which it is possible to separate as completely as possible all recyclable or further processable components from black liquor and at the same time to reduce as much as possible the amount of process water contained in the individual process steps or to be recycled.

To achieve this object, the method according to the invention is substantially characterized in that before a first separation step, the black liquor is concentrated to a solids content of between 25 and 55 wt. % solids content, preferably 30 to 50 wt. % solids content,
in the first separation step, polymeric lignin with a number average of the molecular mass distribution >6 kDa is precipitated by lowering a pH of black liquor to a value in the range of pH 8 to pH 10, preferably about 9.5, and filtered off, whereby a first basic filtrate is obtained in addition to lignin with a number average of the molecular mass distribution >6 kDa
the first filtrate obtained is acidified with sulfuric acid,
a precipitate formed consisting of lignin with a number average of the molecular mass distribution of <6 kDa is separated by filtration and a second acidic filtrate is obtained;
the second filtrate is cooled to a temperature of less than 25° C., preferably less than 15° C., particularly preferably less than 10° C., preferably less than 5° C., whereby a fraction consisting substantially of inorganic salts, in particular Na₂SO₄1.0H₂O (sodium sulfate decahydrate), optionally after addition of seed crystals, is crystallized out;
filtering off the precipitate formed, which substantially consists of inorganic salts, thereby obtaining a third filtrate containing lignin soluble in low-molecular carboxylic acids and residues of the inorganic salts;
optionally returning dried sodium sulfate to the third filtrate and carrying out a second crystallization of Na₂SO₄1.0H₂O;
optionally returning the third filtrate into a pulp production process or
optionally carrying out a reactive extraction of the third filtrate;
optionally evaporating or distilling the third filtrate to obtain a product condensate containing a first fraction containing a plurality of different organic low-molecular acids and a product residue containing at least organic acids and/or polyphenols.

With the method according to the invention it is not only possible to achieve a rapid and reliable fractionation of black liquor into a plurality of recyclable components, whereby substantially only common processes are used which are reliably reproducible and do not require excessive equipment, but also through the acidic precipitation of sodium sulfate decahydrate a large amount of water contained in the process can be removed from the system and thus the amount of water that has to be evaporated in the black liquor evaporation plants of a paper mill is significantly reduced. This involves both a temporal and, in particular, energetic optimization of the black liquor process.

According to the present invention, the black liquor is concentrated to a solids content of between 25 and 55 wt. % before a first separation step in order to avoid excessive liquid loading. The process water accumulated during concentration is returned into the paper or cardboard production process and thereby reduces the fresh water requirement and chemical requirement of the wood pulping process. In a subsequent first separation step, the strongly basic, partially concentrated black liquor, which usually has a pH of about 13 to 14, is acidified by adding carbon dioxide to a pH in the range of 8 to 10, preferably about 9.5, in order to precipitate and separate lignin with a number average of the molecular mass distribution of >6 kDa (lignin with high molecular mass). In this context, it should be noted that the value of >6 kDa is naturally a fluid limit and in the context of the present invention this means lignin with a high molecular mass, which is precipitated and filtered off in the first separation step. The polymeric lignin obtained in this first separation step with a number average of the molecular mass distribution of >6 kDa can either be directly returned to the paper and cardboard production process or separated and purified and used, for example, in paper production as a surface coating material or the like.

The basic filtrate obtained in this first precipitation with a pH of the order of 9 is now acidified in a further step with a strong inorganic mineral acid, in this case sulfuric acid, whereby the pH is further reduced to values of about 2 to 3. By further lowering the pH, a precipitate is again formed which substantially consists of lignin with a number average of the molecular mass distribution of <6 kDa, and furthermore an acidic filtrate is obtained which only contains soluble organic components and inorganic components originating from the black liquor, in particular sulfates and metal ions.

The number average of the molecular mass distribution is understood to be the molar mass of the polymer, here lignin, weighted by the relative number proportion of the polymer. The molar mass is the sum of the masses of each monomer unit that makes up the polymer and the number proportion corresponds to the number of monomer units that make up the polymer.

By cooling the second filtrate to a temperature of less than 25° C., preferably less than 15° C., particularly preferably less than 10° C., preferably less than 5° C., as corresponds to a further process step of the process according to the invention, it is possible to precipitate a fraction consisting substantially of inorganic salts, in particular a sodium sulfate decahydrate. In order to accelerate the precipitation or to carry it out as quickly as possible, as corresponds to the invention, a seed crystal or seed crystals are added to the second filtrate. The sodium sulfate crystallized from the second filtrate can be further purified or further processed or returned to the pulp production process, in particular to the sulfate process. For the most complete precipitation of sodium sulfate decahydrate, it is advisable to select a temperature as low as possible, for example, less than 10° C.

After carrying out the first two precipitation and filtration steps, after separating the sodium sulfate decahydrates, a third filtrate is obtained which mainly contains soluble low-molecular carboxylic acids, soluble lignin and other soluble substances from the black liquor, such as phenolates. The concentration of these organic low-molecular acids, phenols and also the soluble lignin is greatly increased compared to the originally used black liquor, so that a large number of substances that can be directly used in a wide variety of further processes or after purification are obtained from this third filtrate. According to the invention, individual or several consecutive steps of the following are optionally possible, namely
returning all or part of the sodium sulfate previously separated and dried in a separate drying step and thus dehydrated to the third filtrate, dissolving the dehydrated sodium sulfate, preferably at a temperature of about 30° C. in the third filtrate and repeating the sodium sulfate decahydrate precipitation step, whereby the sodium sulfate still contained in the third filtrate is separated even more completely and in particular the water content of the third filtrate can be drastically reduced by the hydrate formation, and/or
the returning the third filtrate into a pulp production process, whereby the contents of the third filtrate are concentrated in the process and optionally after one or more further cycles can be separated or can be used immediately as shown below, or
optionally carrying out a reactive extraction of the third filtrate, by means of which reactive extraction a group of products can be separated from this third filtrate such as low-molecular organic acids such as acetic acid and formic acid,
and/or optionally evaporating or distilling the third filtrate to obtain a product condensate containing a first fraction of various organic low-molecular acids, such as acetic acid and formic acid, and a product residue containing organic acids, such as lactic acid and glycolic acid.

By carrying out the process according to the present invention, it is therefore not only possible to significantly reduce the amount of water that has to be circulated in the process, but also to separate a particularly large number of different contents from the black liquor that can possibly be used separately and, in particular, by applying the precipitation steps, to increase the concentration of soluble, low-molecular organic acids such as phenolic acids and the like, in the third filtrate to such an extent that they can be separated separately and supplied for further use. Naturally, according to the invention it is possible to repeat the individual process steps and thus achieve an even better purification or separation.

Furthermore, it is possible that the third filtrate is added directly to the pulp production process as an adjuvant. For example, it can be used to neutralize process waste water in the production of unbleached paper; as an acidifying agent in a pre-hydrolysis process of the kraft process; as a neutralizing agent for brown liquor; as an acidifying agent in a bleaching liquor; to replace fresh water and inorganic acid in the production of machine glazed paper or to partially replace sulfuric acid in tall oil production. As a result of this use of the third filtrate, not only can the overall energy balance of the process be improved but overall a number of valuable additives can be reintroduced into the paper and/or cardboard production process, which would otherwise have either been discarded or not specifically recycled.

By carrying the process in such a way that the precipitation of lignin with a number average of the molecular mass distribution >6 kDa is carried out by lowering the pH of black liquor by means of CO₂, as corresponds to a further development of the invention, it is possible to separate the lignin contained in the black liquor by means of precipitation steps at different pH, whereby in a first step those lignin fractions are precipitated at a basic pH value which have a particularly high molecular weight or number average of the molecular mass distribution. This lignin fraction can, as is known to a person skilled in the art, be used directly in paper production and can also be used, for example, to improve the surface of paper. The use of lignin in paper production is known to those skilled in the art, and problems that can arise due to a lignin content in the paper or cardboard, such as the greying of paper, are also known to those skilled in the art, so that lignin in paper production is usually used in the production of brown, unbleached paper or is left in the pulp.

By carrying the process in such a way that the first filtrate is acidified with sulfuric acid to an acidic pH >2, preferably a pH between 2 and 3, as corresponds to a further development of the invention, it is possible to precipitate a second lignin fraction, which lignin fraction has a reduced molecular weight compared to the first precipitated lignin fraction. This fraction can possibly be used directly in paper production since it does not colour the paper as much and makes it less brittle than lignin with a higher number average of the molecular mass distribution. Surprisingly, however, it has been shown that due to the two-stage precipitation of lignin from black liquor not only is it possible to separate significantly higher amounts of lignin from the black liquor, but in particular the valuable low-molecular organic acids contained in the natural product wood can be concentrated in the filtrate formed after the second precipitation of lignin, without them being carried along and co-precipitated during the precipitation of lignin. It was surprisingly found that in the process according to the invention, only very low concentrations of about 0.05 g/kg of organic, low-molecular acids were entrained and separated in the individual separation steps, and the second filtrate had a slightly increased concentration of low-molecular carboxylic acids in the range of 50 g/kg compared to the original black liquor.

Since substantially pure Na₂SO₄1.0H₂O is crystallized from the second filtrate containing inorganic salts, in particular Na₂SO₄1.0H₂O and the low-molecular acids such as lactic acid, glycolic acid, formic acid, vanillic acid, ferulic acid, hydroxybutanoic acids and acetic acid remain in the filtrate, two effects are achieved: on the one hand, the filtrate is depleted of inorganic substances and the sodium sulfate can be precipitated almost quantitatively. Since the sodium sulfate precipitates as decahydrate, the water content of the filtrate is greatly reduced and the concentration of organic low-molecular acids remaining in the filtrate is thereby further increased. As a result of this step, the concentration of low-molecular carboxylic acids in the filtrate can be increased to more than 100 g/kg. This facilitates any subsequent separation steps and leads to a high yield of low-molecular organic acids at the end of the process.

In order to further increase the concentration of the low-molecular organic acids in the second filtrate, the process according to a further development of the invention is carried out in such a way that the crystallized-out sodium sulfate decahydrate is subjected to drying, added to the second filtrate and crystallized again by cooling and optionally seeding. In this procedure, during drying of the sodium sulfate decahydrate the water of crystallization is released and evaporates, forming anhydrous sodium sulfate which, as is known, acts as a drying agent and can be used. This anhydrous sodium sulfate is returned to the filtrate of the first crystallization, where it again dissolves at temperatures of about 30 to 35° C. The recent cooling of this filtrate to temperatures below 25° C., preferably below 10° C., leads to a new precipitate of sodium sulfate decahydrate, whereby further water is removed from the process. By removing water from the process, the concentration of low-molecular organic acids contained in the remaining filtrate is increased even further. The low-molecular organic acids contained in the third filtrate include at least lactic acid, glycolic acid, formic acid, vanillic acid, ferulic acid, hydroxybutanoic acids and acetic acid, which can be separated from one another in a further step using fractionation technologies.

In this context, it is unnecessary to note that the black liquor used as starting material contains a very large number, usually more than 100, different low-molecular organic acids, which in principle can be separated using the process according to the invention and separated by means of known methods. The acids mentioned, namely lactic acid, glycolic acid, formic acid, vanillic acid, ferulic acid, hydroxybutanoic acid and acetic acid, are either the most important acids from an economic point of view or represent the largest fraction contained in the starting material in terms of quantity. According to a further development of the invention, the process is carried out in such a way that the reactive extraction of the third filtrate is carried out using a mixture containing an organic solvent such as 1-octanol and at least one of trioctylphosphine oxide (TOPO) or trioctylamine (TOA) at temperatures between 20 and 80° C. By adding reactive ion exchangers such as trioctylphosphine oxide or trioctyl amine with a mixture containing at least one organic solvent it is possible to separate low-molecular acids such as acetic acid, thereby further reducing the number of components remaining in the eluate of this purification process. In this case, the aqueous eluate of the purification process mainly contains residual salts.

By carrying out the process in such a way that evaporation or distillation of the third filtrate is carried out as a steam distillation to separate volatile low-molecular carboxylic acids, as corresponds to a further development of the invention, it is possible to remove more than 50% of the formic acid and acetic acid with an extremely high purity, so that in addition to or as an alternative to the treatment with a reactive ion exchanger, a further possibility is offered to separate acetic acid and other low-molecular acids from the filtrate. After evaporation or distillation or after treatment with a reactive ion exchanger, a remaining product residue is further processed according to a further development of the invention to obtain the phenolic components, in particular vanillin or vanillic acid and/or ferulic acid. Such further processing for commercial use can, for example, consist in concentrating the product residue, whereby other possibilities, in particular to obtain a separation of the phenolic components in the product residue from the remaining acids, such as lactic acid and glycolic acid or even formic acids, are introduced into the process according to the invention as a further step by means of which the filtrate is thickened before acidifying the first filtrate with sulfuric acid in order to further increase the solids content in this filtrate. With such an increase in the solids content, the saponification of the acids contained in this filtrate is further completed with the existing alkali, so that entrainment of acids during evaporation is prevented and only water is evaporated.

Surprisingly, with the process according to the invention sodium sulfate could be precipitated almost quantitatively, despite the presence of dissolved and partially polar organic substances. This almost quantitative crystallization is surprising since it is known to the person skilled in the art that organic substances, in particular polar organic substances, prevent the crystallization of inorganic salts and furthermore, the existing acidic filtrates from paper and pulp production not only contain sodium ions but also, for example, large amounts of potassium ions, which would also interfere with the crystallization of sodium sulfate or contaminate the crystals, which, surprisingly, is not the case.

With the method according to the invention it is thus possible to provide a purification process by means of which a large number of economically valuable products can be obtained from black liquor, which can either be used directly or can be subjected to further processing.

### DESCRIPTION OF THE DRAWINGS

The invention is explained in more detail below with reference to figures and exemplary embodiments.

FIG. 1 shows a flow diagram for a process for the isolation of lignin from black liquor and for the separation of sodium sulfate from a filtrate containing organic low-molecular acids and phenol-containing components and

FIG. 2 shows a process for the fractionation of black liquor to obtain various recyclable end products.

### DETAILED DESCRIPTION OF THE INVENTION

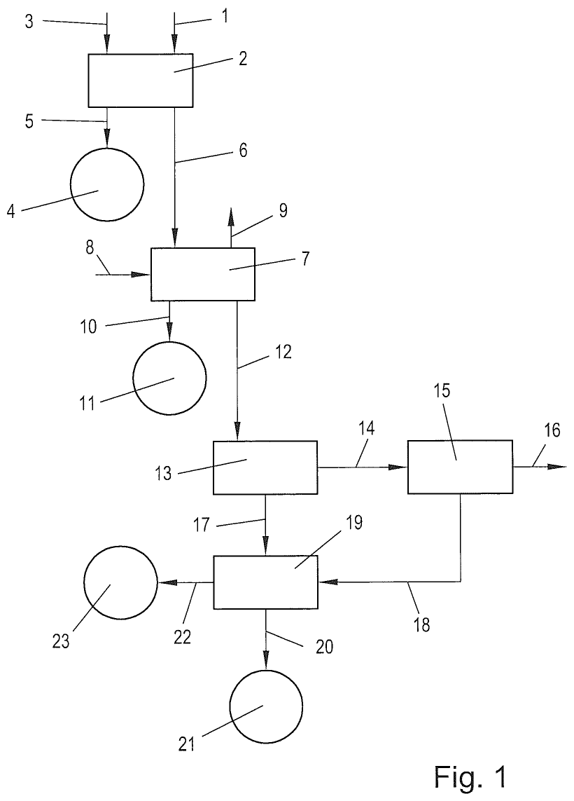

Example 1 describes, with reference to FIG. 1, a process for isolating lignin from black liquor and for separating sodium sulfate from a filtrate containing organic low-molecular acids and phenol-containing components and the recovery of these acids and phenol-containing components.

In the fractionation process according to the invention described in FIG. 1, in a first step a mass flow 1 consisting of black liquor from a kraft process with a pH of about 13 and a content of 40 to 46 wt. % dry substance in the black liquor is introduced into a precipitation tank 2 and there continuously mixed with a second flow 3 consisting of carbon dioxide gas. Here, the pH of the black liquor is lowered to about pH 9, whereby lignin with a number average of the molecular mass distribution of >6 kDa is precipitated in a first precipitation and separated from the precipitation tank 2 using known measures and introduced into a storage tank designated 4 via a line 5, and can be temporarily stored therein. Naturally, direct further use of lignin with a number average of the molecular mass distribution of >6 kDa is also conceivable, for example in common thermosetting resins and as an additive to thermoplastic resins.

The filtrate from the first precipitation consisting of a lignin-depleted black liquor with a pH of about 9 and a reduced solids content of about 35 to 38 wt. % solids, such as lignin with a number average of the molecular mass distribution of <6 kDa, inorganic salts, low-molecular organic acids and phenolic products as well as the remainder water is fed via a line 6 to a second precipitation tank 7, in which an acid precipitation is carried out with sulfuric acid at about pH 2, which is fed to the container via line 8. The gas produced during this precipitation, mainly CO₂ and H₂S, is removed at 9 and after purification can optionally be re-used in the paper or pulp manufacturing process. The lignin precipitated during the second acid precipitation with a number average of the molecular mass distribution of <6 kDa is separated at 10 and stored in an intermediate storage tank 11. The lignin with a number average of the molecular mass distribution of <6 kDa can then be used either in the same way as the lignin with a number average of the molecular mass distribution of >6 kDa in thermosetting resins or as an additive to thermoplastic resins or, due to the improved solubility and processability as well as the melting point, it can be used directly in paper production together with starch in surface applications to strengthen the hydrophobic paper sizing, as an antioxidant for the preservation of chemicals and/or cleaning agents and food/animal feed.

The acidic filtrate from the second lignin precipitation with a pH of about 2 is fed via line 12 to a first crystallization 13. Here the filtrate is cooled to a temperature of below 10° C., preferably below 5° C., and since sodium sulfate decahydrate does not usually precipitate spontaneously during cooling, crystallization is started by adding seed crystals. The precipitated sodium sulfate decahydrate crystals are removed at 14 and dried in a drying vessel 15 at a temperature of more than 35° C. The water accumulated during drying is drained off via line 16 and can be re-used in the process. In the same way, the dried sodium sulfate crystals formed, which are now anhydrous after drying, can be combined, for example, with the filtrate drawn off at 17 from the first crystallization by feeding them via line 18 to a second crystallization in a precipitation vessel 19. The filtrate from this crystallization is also drawn off at 20 and collected in container 21, in the same way the sodium sulfate decahydrate crystals formed are drawn off at 22 and collected in the container 23.

It is unnecessary to note that the crystallization of sodium sulfate decahydrate can be carried out as often as necessary until no more sodium sulfate can be formed, since the filtrate is so depleted that no more sodium sulfate decahydrate can be precipitated or all the water in the filtrate has been absorbed by the sodium sulfate converted into its decahydrate. This measure makes it possible to significantly reduce the water content of the process, especially the processing and filtration process, whereby both energy and washing substances can be saved and also the resulting target substance, namely sodium sulfate decahydrate can in turn be transferred into a water-free product or an anhydrous crystal by applying a relatively low heat, whereby on the one hand a depletion of water was achieved and on the other hand a very valuable starting material, in particular a dry material, could be obtained. By precipitating sodium sulfate decahydrate, on the one hand with a corresponding number of precipitations, almost all of the water can be removed from the process, the resulting sodium sulfate can be re-introduced into the black liquor to keep the sodium/sulfur balance in equilibrium, and finally the so-called non-process chemicals, such as chlorine, for example, potassium in the first filtrate or in the filtrate of the last crystallization can be removed from the process, which constitutes a significant advantage in paper production. Finally, the last filtrate obtained can also be used directly in animal feed, since its content of organic acids and phenols, which have a positive effect on the health of farm animals, is comparatively high. Further purification of this filtrate is naturally also possible.

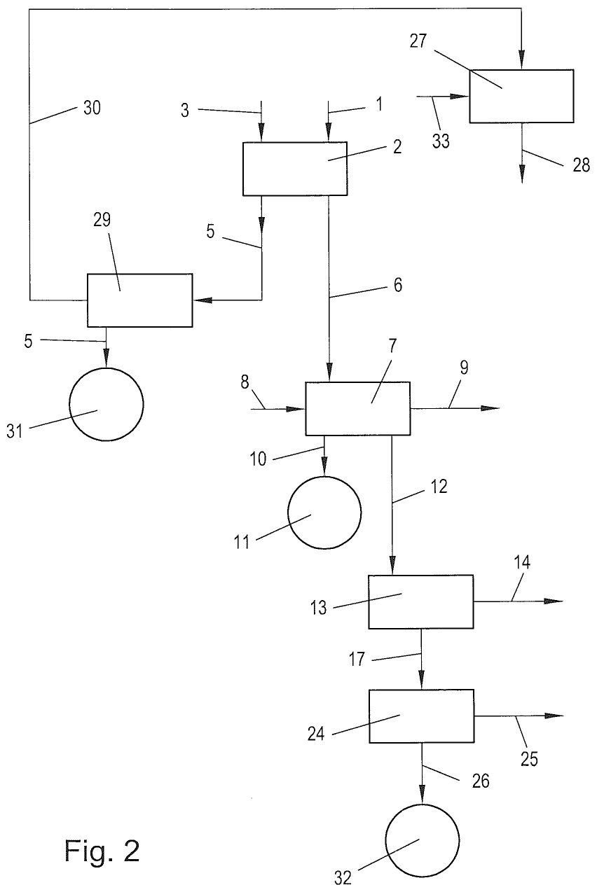

FIG. 2 shows a process flow for the fractionation of black liquor to obtain various recyclable end products. According to FIG. 2, the reference numerals of FIG. 1 are retained as far as possible. At 1, black liquor, for example 1 kg of black liquor with a content of 45% dry substance, the remainder water and a pH of 13, is introduced into a precipitation tank 2. In this tank 2, this black liquor is gassed using the CO₂ pressurized at 3, whereby lignin is precipitated. The precipitated lignin is discharged via line 5 as a lignin filter cake with a high molecular weight, whereby approximately 0.27 kg of lignin and 0.094 kg of water are removed. At 6, a lignin-depleted filtrate is drawn off from the precipitation vessel 2, which is substantially free of foreign substances and has a pH of about 9. The filtrate weighs about 0.74 kg and contains about 0.46 kg of water. About 0.16 kg of H₂SO₄ are introduced into the precipitation tank 7 at 8 and an acidic lignin precipitation is carried out. The CO₂ gas and the H₂S produced here are drawn off via 9. Precipitation with sulfuric acid produces about 0.166 kg of a filter cake, which consists of about half water and the other half lignin with a molecular weight <6 kDa. The acidic filtrate also formed weighs about 0.69 kg and contains about 0.43 kg H2O. This product is withdrawn from the vessel 7 at 12 and subjected to a single sodium sulfate crystallization in a crystallization vessel 13. In this case, approximately 0.395 kg of sodium sulfate decahydrate is formed, which is withdrawn from the system at 14. The filtrate from the crystallization is drawn off via the line 17 and subjected to evaporation or, optionally, further distillation in an evaporator 24. At 25 a product condensate is withdrawn which contains formic acid, acetic acid and water in an amount of about 0.225 kg. The bottom product 32 of the distillation is withdrawn at 26 and contains as main components lactic acid and glycolic acid in an amount of about 0.073 kg. The products from the evaporator 24 can either be further purified or immediately supplied for further use. They are important additives for, for example, animal feed or raw materials for further production steps.

In comparison, as also shown in FIG. 2, if the starting material used, namely 1 kg of black liquor containing about 0.55 kg of H2O, is subjected to evaporation, for example in an evaporator 27, it is necessary to evaporate about 0.48 kg of H₂O in order to obtain a so-called heavy black liquor or thick liquor with about 85 % dry substance, which could be returned to the black liquor combustion boiler. In the process according to the invention, a product condensate is withdrawn in the evaporation-distillation step 25, which contains only 0.20 kg H₂O, from which it can be seen that only about half the amount of water has to be evaporated due to the binding of the water in the sodium sulfate decahydrate. Sodium sulfate decahydrate is able to bind water more quickly and reliably. Due to the ten waters of crystallization, large amounts of water are removed from the system and sodium sulfate decahydrate can be converted into anhydrous sodium sulfate even at extremely low temperatures, which are just above 35° C., so that a significant energy saving can be achieved in the process according to the invention. If the precipitation step is carried out several times, theoretically almost all the water can be removed from the system exclusively via precipitation as sodium sulfate dehydrate.

Finally, the lignin filter cake removed at 5 could be subjected to an acid wash 29 and the acid product washed with water supplied via line 33. The used washing liquid can, for example, be returned to the evaporator 27 via a line 30. In this step, a further purified lignin can be withdrawn from the washing device at 31, which has a high molecular mass and only relatively small amounts of water. Here, for example, 0.27 kg of lignin and 0.09 kg of water can be recovered at 31.

In summary, it can be seen that due to the precipitation step with sulfuric acid introduced according to the invention to form sodium sulfate decahydrate, the amount of water to be circulated can be greatly reduced or even completely removed. In this case, for example, half of the evaporating water can be removed if the precipitation step is carried out once, as well as larger amounts if the precipitation step is carried out several times, resulting in considerable energy savings in a process carried out according to the invention. Furthermore, the residual products can be further processed in a meaningful way, for example in the production of animal feed.

1. A method for separating water and at least one lignin fraction, lignin derivatives, low-molecular carboxylic acids, sodium sulfate or a mixture thereof from filtrates originating from black liquor from a kraft process, wherein
before a first separation step, the black liquor is concentrated to a solids content of between 25 and 55 wt. % solids content,
in the first separation step, polymeric lignin with a number average of the molecular mass distribution >6 kDa is precipitated and filtered off by lowering a pH of black liquor to a value in the a range of pH 8 to pH 10, whereby a first filtrate is obtained in addition to lignin with a number average of the molecular mass distribution >6 kDa,
the first basic filtrate obtained is acidified with sulfuric acid,
a precipitate formed consisting of lignin with a number average of the molecular mass distribution of <6 kDa is separated by filtration and a second acidic filtrate is obtained;
the second filtrate is cooled to a temperature of less than 25° C., whereby a fraction consisting substantially of inorganic salts, is crystallized out, after addition of seed crystals;
filtering off the precipitate formed, which consists substantially of inorganic salts, whereby a third filtrate containing low-molecular carboxylic acid-soluble lignin and residues of the inorganic salts is obtained;
returning dried sodium sulfate to the third filtrate and carrying out a second crystallization of Na₂SO₄1.0H₂O; and/or
returning the third filtrate into a pulp production process or
carrying out a reactive extraction of the third filtrate;
evaporating or distilling the third filtrate to obtain a product condensate containing a first fraction containing a plurality of different organic low-molecular acids and a product residue containing at least organic acids and/or polyphenols.

2. The method according to claim 1, wherein the precipitation of lignin with a number average of the molecular mass distribution >6 KDa is carried out by lowering a pH of black liquor by means of CO₂.

3. The method according to claim 1, wherein the first basic filtrate is acidified with sulfuric acid to an acidic pH greater than 2.

4. The method according to claim 1, wherein substantially pure Na₂SO₄1.0H₂O is crystallized from the second filtrate containing inorganic salts.

5. The method according to-one claim 1, wherein the reactive extraction of the third filtrate is carried out using a mixture containing an organic solvent, 1-octanol, and at least one of trioctylphosphine oxide or trioctylamine at temperatures between 20 and 80° C.

6. The method according that claim 1, wherein evaporation or distillation of the third filtrate is carried out as steam distillation to separate volatile low-molecular carboxylic acids

7. The method according claim 1, wherein a product residue remaining after evaporation or distillation of the third filtrate is further processed to obtain phenolic components.
